(19) United States
(12) Patent Application Publication
(10) Pub. No.: US 2015/0019363 A1
(43) Pub. Date: Jan. 15, 2015

(54) METHOD AND SYSTEM FOR CONDUCTING A LIVE INTERACTIVE AUCTION OVER THE INTERNET

(71) Applicant: Lloyd Schwartz, Albuquerque, NM (US)

(72) Inventor: Lloyd Schwartz, Albuquerque, NM (US)

(21) Appl. No.: 13/941,536

(22) Filed: Jul. 14, 2013

(51) Int. Cl. G06Q 30/08

(52) U.S. Cl. CPC G06Q 30/08
USPC 705/26.3

(57) ABSTRACT

A method and system for selling goods over the internet including a live, real-time interactive online auction with communication between the auctioneer and registered prospective bidders.

### RELATED APPLICATIONS

This application claims priority to provisional patent application No. 61/672,653 entitled Online/Live Auction Process filed Jul. 17, 2012. This application incorporates by reference the disclosure in the above-identified provisional application.

### BACKGROUND OF THE SUBJECT MATTER

Traditional auctions typically involve the physical gathering of goods to be sold at a location ostensibly convenient for attendance by prospective buyers. The auction is scheduled at a particular time and place and that information is made available to a class of buyers or to the public generally using a variety of media. Buyers attend the auction at the designated location. Buyers typically show-up at the location prior to the sale to inspect the goods that will be made available for sale. Then the buyers must wait during the auction for the goods that they desire to bid on to be offered. There are a number of problems in the traditional auction. For example, the buyer may not have sufficient time to inspect the goods permitting a personal valuation in readiness to bid. The auction requires prospective bidders to attend at a location that may not be convenient and involving travel expenses. Considerable time can be consumed by waiting at a location that is not comfortable. The goods generally have a high value that justifies attendance with the disadvantages just mentioned. From the seller's point-of-view, the physical delivery of the goods to the auction site may be expensive and require pre-arrangements to be made for delivery prior to the day of auction. The delivery costs are particularly disadvantageous if the goods do not sell at the auction since they must be removed and returned to the sellers' premises; this may induce the seller to sell the goods at some sub-optimal price. Furthermore, the prospective buyers may not be adequately informed as to the exact nature of the goods from the marketing or other pre-auction materials and thus may be uncertain as to whether they should attend; this failure to adequately inform may not draw the best potential buyers and thus adversely affect the hammer price. Another problem with traditional auctions is that the value of the goods offered must be substantial to justify an adequate compensation for the auction holder.

Sale of items on the interne, such as on eBay, is well known and fulfills a certain need in the marketplace. However, it does not include a live auction but rather uses a period for soliciting bids and after a set period, declares the successful bidder who after payment is shipped the goods by mail or other carrier of goods. One disadvantage of this passive auction method is that it lacks the emotional excitement of live bidding. A live auction generates enthusiasm and competitive bidding that appeals to many purchasers of used and new products. There are also problems regarding collection of payment, or conversely, failure of the seller to send the goods. The system operator must have complicated rules to address the collection/failure-to-ship problems complicating the administration of the operation and raising costs. Moreover, because there may be a large number of products offered for sale simultaneously, it is difficult for the system operator to organize the goods in intuitive categories that makes it easier to for prospective bidders to find items that interest them. On the other hand, many auction sites on the interne are dedicated to particular classes of products, such as automobiles. However, because of taxonomic indefiniteness, goods that do not appear on a dedicated site may be of interest to purchasers, such as a person shopping for a motor scooter who might ordinarily not frequent an automobile auction site and. thus a good match between seller and buyer is not accomplished.

Another common method for selling used goods is the traditional garage sale in which a seller, alone or in conjunction with others, offers goods previously purchased and likely used. That method too suffers from the cost of attendance in time and money, no opportunity to preview the goods and therefore to justify the visit, and the too often sale of junk that the purchaser would not be interested in. To a certain extent, second hand stores also compete for purchasers of the type interested in shopping in the above-described manner. However, this method is expensive for the seller, who has fixed overhead, requires buyers to personally visit the store, and is otherwise subject to the same deficiencies as those described above.

### SUMMARY OF THE INVENTION

The present invention, as described below with respect to one embodiment, overcomes some or all of the above-described disabilities by uniquely combining networked communication capabilities of the internet for millions of computer-users and mobile device users in conjunction with holding a live auction. The process is capable of implementation in a variety of ways based on core functionalities and steps of the system and method, and comprises the following activities and steps in an exemplary embodiment of the invention. The method involves operation of a website on the internet, registering potential buyers, arranging for auctions with various sellers, inventorying, tagging and photographing goods, preparing and displaying goods on the website, announcing a date for the auction, permitting registered bidders to bid prior to the auction, conducting a live auction in real time that is broadcast as a streaming online video presentation where remotely located bidders may bid in competition with other remotely located bidders and may communicate with the auctioneer over a chat line, receiving multiple bids and determining the highest bidder, announcing the winning bid, collecting payment, and authorizing the successful bidder to pick up the goods from the seller's location.

### BRIEF DESCRIPTION OF THE DRAWINGS

FIG. 1 is a diagram of one embodiment of the system for conducting a live auction over the internet; and

FIG. 2 is a workflow diagram of the method performed by the one embodiment of the system.

### DETAILED DESCRIPTION OF ONE EMBODIMENT OF THE INVENTION

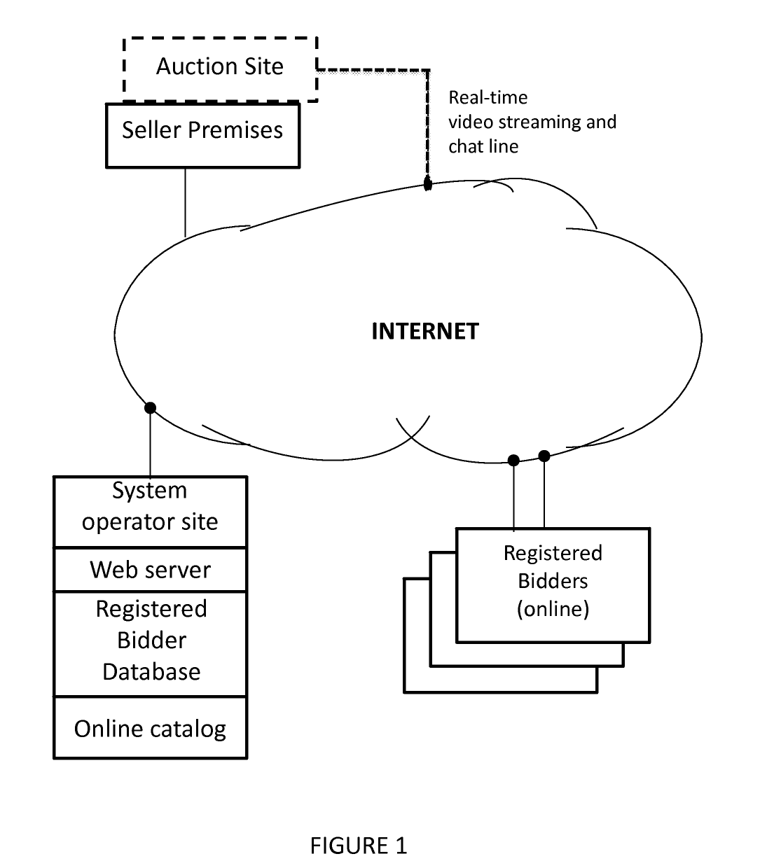

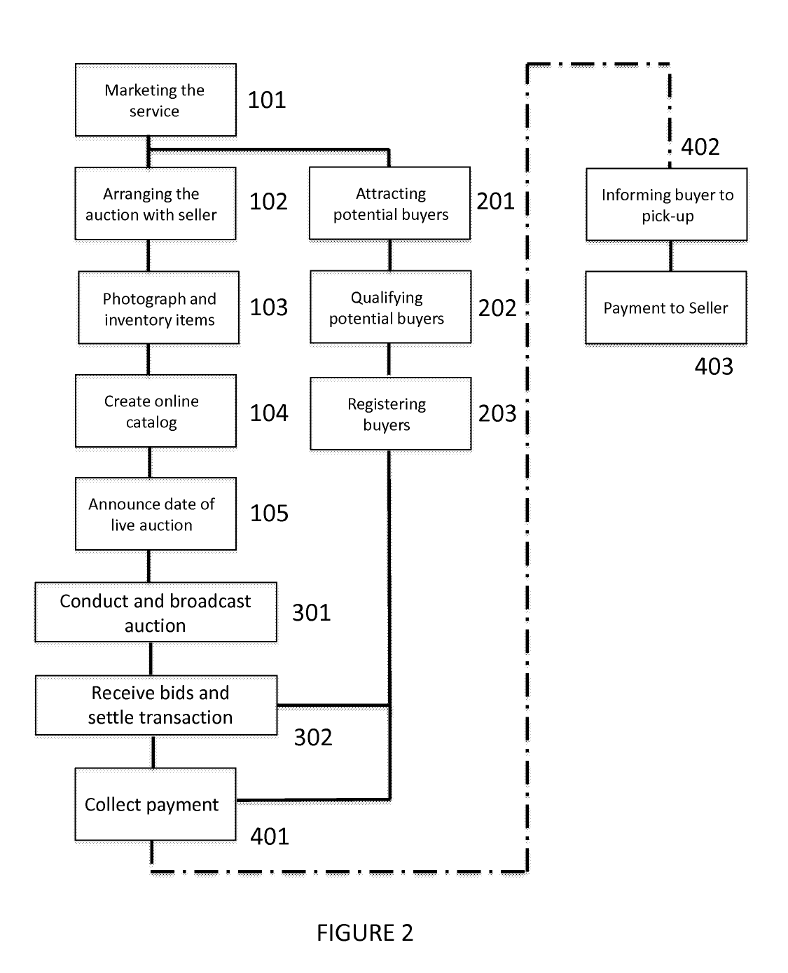

Referring now to FIG. 1, the internet is shown as a cloud to which a plurality of registered bidders are connected online, a seller's premises, and a system operator's site including a computer with a web server, a database of registered users, and an online catalog. As described below, a seller's premises is also connected to the internet at the time of the real-time auction, the connection capable of video and chat line communication with other online participants. In implementation, the system operator procures an online website, preferably one with a desirably suggestive domain name and commences advertising the service 101 as shown in the workflow diagram of FIG. 2. Other traditional marketing activities may be employed to make potential customers aware of impending auctions.

Prospective sellers contact the system operator indicating a desire to sell goods, whether used or new, The system operator visits the seller's premises, a home, or other facility that the seller may control and where the goods are stored. For example, in addition to a private home sale, the seller may be liquidating a business, or decreasing inventory for financial or relocation reasons at one of several business locations. A seller may control a storage site from which, for example, overstocked goods are sold. In the case of a storage auction, the entire lot of goods may be sold in a single transaction; otherwise the following description is similar to auctions where goods are sold piece by piece. An agreement is entered between the system operator and the seller 102. The seller promises that identified goods will not be sold through any alternative process prior to the auction. A date for the auction may be agreed upon. The seller may set various auction parameters, such as minimum opening bid, minimum hammer price, bidding increments tailored to individual goods based on perceived value, and whether the auction will be without reserve. The system operator agrees to advertise the auction and display the goods online and use its best efforts to sell the goods at auction. The agreement may cover other related matters that will become clear from the following more detailed description. For example, the seller may be offered the opportunity to remove any of the goods from the sale prior to the day of auction subject to the agreement that the seller will not sell the goods before the auction, and some specified period of time, has passed.

The system operator then creates an inventory of items for sale, tags the items to be sold, and photographs the goods to fully illustrate the type, condition and features of the goods 103. A short written description may be prepared to complement the photos. The seller and system operator may agree on selling the goods individually or in lots and participate in how the goods will be displayed and arranged in sequence during the auction.

The system operator then creates an online catalog for that specific seller 104 displaying the goods and sets an auction date with sufficient time for potential bidders to become aware and to inspect online the suitability of the goods for their specific purposes. The catalog is then posted on the operator's website and the date of the live auction is announced 105. The system operator may display catalogs from multiple sellers simultaneously. Each seller is individually identified on the prepared tags.

The system operator, in addition to soliciting sellers, solicits and creates a bidder registry or membership 201. Each member is provided with a unique bidder number for use in bidding at any time and on any catalog sale. The registration may be for a fixed period or indefinitely. Various conditions and limits may be placed on a particular registered bidder 202. For example, an age restriction and proof of age by driver's license number, post office and email address, financial limits such as by requiring a PayPal account number, credit card number, or deposit account. Other restrictions and conditions will be obvious to those of ordinary skill in the art and when met, the bidder is registered at 203.

A registered bidder may place a bid during a pre-auction period, after the catalog is published, by submitting a bid by email. The bids may be made public or maintained, in confidence. In the latter event, when an existing bid is topped, the system operator may manually or automatically send out a notice to all prior bidders that their bid has been topped. These bids are known as “proxy bids.”

After a predetermined period selected by the seller and system operator, an auction is held. The auction is held on the seller's premises. The system operator provides an auctioneer-agent and a clerk to conduct an open bid, real-time, live auction 301. A live streaming, video broadcast over the internee is conducted with or without bidders on site. Online registered bidders may remotely bid and may also interactively chat over an online communication link with the auctioneer in real time 302. The chat line offers bidders the opportunity to request, for example, that items be combined into a single lot with a single bid, to go back to an earlier item that was not sold and permit bids, to change an opening bid threshold, and the like.

The auctioneer proceeds to offer items in a manner well-known in the art to the highest bidder. The auctioneer may lower opening bids, combine lots, or exercise other common auction techniques to attract higher bids and otherwise complete the sale 302.

Lots are marked with numbers, successful bidder number, price and other pertinent information for completing the transactions. Unsold items may be left online for attracting other bids for a selected period of time agreed upon by the seller and the system operator or may be immediately removed. At the end of the period clear title to the goods revert to the seller.

Members are notified of their successful bid and payment is demanded in the above-described manner as shown at 401. When notice is received by the system operator that payment has been received, the member is notified by email of the location of the goods, directions to the seller site, time for pickup as selected by the seller, and other information necessary to complete delivery and transfer of possession of the goods 402. The proceeds less the system operator's commission is paid to the seller 403.

The system operator, as indicated above, may have multiple catalogs available at any one time, each having an individual auction date. As described, there may be variations and additions in the steps that comprise the entire process with the core being a combination of internet capability for messaging, broadcasting, noticing, displaying and conducting a live interactive auction with remote registered bidders. For example, steps in the delivery of the goods from seller to buyer may be by pick up or alternatively by delivery by the system operator, the seller, or a third party service. Or, pre-auction bids may not be allowed. Or the live auction may be conducted at a site not controlled by the seller, for example, small items involving minimal transportation costs may be auctioned from the operator's facility. The online catalog may be updated prior to the bid as the seller desires to add additional items. Or the seller may deliver the goods to the successful bidder with or without an additional fee. Or an auction may be dedicated to a particular type or kind of common goods, such as jewelry. Or the system operator may extend credit to a bidder and finance the sale or the seller, for expensive items may agree to accept payments from the successful bidder. Other variations will be apparent to one of ordinary skill in the art.

The process described above illustrates the advantages of the novel system and method of the present invention as described here with respect to one embodiment. The process is relatively inexpensive, compared to some other types of transactions because of the existing internet that networks large numbers of potential sellers and buyers of both new and used goods. In particular, recent technology advances such as live streaming video at relatively low cost makes possible the combination of the interact with a live auction. Low cost reduces the operator's expenses and allows a more modest commission compared to other types of auctions. And that enables the seller to sell relatively low cost goods, comparable in price and quality to traditional estate and garage sales. The described embodiment shows that there is greater convenience to the bidders who do not need to travel to a remote site and spend the time in a serial auction while still attending the auction while engaged in watching, for example, a sporting event and periodically tuning in to the auction. Furthermore, the potential bidders, at their convenience, may inspect the items offered in an upcoming auction. Photos may be comparable to those in any online catalog, and the seller may cooperate with the system operator to describe unique features of the goods.

From the seller's perspective, the described embodiment of the invention, shows that it involves much less hassle such as dealing with people who are tire-kickers. The seller obtains more exposure than any amateur cardboard street sign marketing typically used for garage sales and thus may reap better sales prices for that reason. Nor does it involve transportation of goods to an auction site. Many of the transactions are simple and quick as may be desirable based on the sale accompanying a move out-of-state where the sellers are harried in light of such disruption in their daily lives. The seller does not have to be concerned with successful bidders that do not pay since he or she is dealing with a continuing business that has pre-qualified bidders to assure financial responsibility and sanctioning, if the bidder is a deadbeat. The seller is least interrupted except on the day of pickup and may even avoid that task by contracting with the system operator.

The terminology used herein is for the purpose of describing a particular embodiment of the invention and is not intended to be limiting on the scope of the invention. The singular terms, “a,” “an” and “the” are intended to include the plural unless the context clearly indicates otherwise.

As noted above, many variations and modifications of the described embodiment may be altered by one of ordinary skill in the art without departing from the scope and spirit of the invention. The particular embodiment described was chosen for the purpose of enabling those skilled in the art to understand and practice the invention including modifications that may be suitable for auctioning certain types of goods, or in certain geographic areas of the country, or utilizing further advances in communication technology that continues to innovate and foster communication of multiple remote users.

I claim:

1. A method for live auctioning goods utilizing the Internet comprising:
creating a website;
soliciting, qualifying and registering bidders having selected capabilities;
contractually arranging for the sale of goods with selected sellers;
visiting a location of the seller and preparing information for display on the website including still photographs of the goods offered for sale;
preparing a catalog of the goods including a photograph of the goods;
displaying the catalog of the goods on the website available for purchase;
permitting pre-auction bids to be made online by registered bidders;
establishing and announcing a date for a live auction at the seller's premises;
conducting and broadcasting an interactive, real-time, live auction with an auctioneer, available for viewing online and for interactive communication between viewers and the auctioneer online;
receiving bids in real time from registered bidders and announcing the hammer price;
notifying the winning bidder;
receiving payment from the winning bidder for goods purchased; and
permitting the successful bidder to obtain possession of the goods.

2. The method of claim 1 wherein the website includes information on how to sell and/or buy using the method.

3. The method of claim 1 wherein the entire process takes place with the goods in the seller's possession.

4. The method of claim 1 wherein the qualification of bidders includes the ascertainment of financial information.

5. The method of claim 4 wherein the qualification of bidders includes a method of payment such as a credit card or other established method of payment.

6. The method of claim 1 wherein the contractual arrangement with the seller includes establishing minimum bids for selected goods.

7. The method of claim 6 wherein the contractual commitment with the seller includes agreement to not sell the identified goods prior to the auction date.

8. The method of claim 1 wherein the seller is notified when payment has been received and to release the goods to the successful bidder upon request.

9. The method of claim 8 wherein permitting the successful bidder to pick-up the goods includes scheduling pick-up of the goods from the seller.

10. The method of claim 9 wherein the system operator directly or indirectly picks up and delivers the goods to the successful bidder after payment has been made.

11. The method of claim 1 wherein the entire process takes place without movement of the goods from the seller's premises until the goods are sold.

12. The method of claim 11 wherein during the live auction the registered bidders may communicate with one another.

13. The method of claim 1 wherein the auctioneer may combine goods into lots to promote sale.

14. The method of claim 1 wherein registered bidders are provided with a secure location on the website to store information such as bids made, goods won, bids outstanding, goods released for pick-up and related matters.

15. The method of claim 1 wherein the a commission based on the price of the goods sold is charged to the seller or to the buyer, or both,

16. A system for operating a live auction of goods on the internet based on an arrangement between a system operator and a seller, comprising;
a computer system located at an operations center, said computer system in communication with the internet;
said computer system configured to execute a plurality of processes;
one or more processes stored in computer readable memory and executing on said computer system to perform:
storage of information relating to goods to be sold at auction based on an online catalog including, a photograph obtained from a remote seller's premises where the goods are located, and were tagged for identification and seller identification throughout the auction proceeding;
communication with remote computer systems over the internet to display the goods available for auction and setting a time at which a live auction will be conducted at the seller's premises;
recording bidder registration information including a member number for participating potential bidders at online remote sites and permitting bids to be received and recorded only from registered bidders for tagged goods;
permitting registered bidders to make pre-auction bids;
broadcasting online streaming video and communication between bidders and the auctioneer from a live auction conducted by the system operator at the seller's premises;
receiving bids during the live auction, recording each bid, and displaying the last bid to participating bidders at their online remote sites;
recording the winning bid including the goods tag, the member number and the hammer price;
providing notice to the successful bidder over the internet and requesting payment in the amount of the winning bid and any commission charged by the system operator;
recording receipt of payment from the successful bidder;
notifying the successful bidder that the goods are available for pickup at the seller's premises, the seller's location and the seller's instructions for pickup; and
notifying the seller that payment has been made and obtaining seller's pickup instructions.

17. The system of claim 16 additionally comprising conducting the entire process while the goods remain at the seller's premises.

18. The system of claim 16 wherein the system operator or its agent picks up the goods and delivers them to the successful bidder.

19. The system of claim 16 wherein the auctioneer-agent of the system operator sets minimum bids for particular goods, combines goods into lots for more expeditious handling, and notifies prospective bidders if the goods to be sold are subject to reserve.

20. A method for live auctioning goods at a seller's premises utilizing the internet for broadcasting the auction and receiving bids from registered bidders over the internet comprising:
creating a website;
registering bidders;
arranging for the sale of goods with selected sellers;
visiting the seller's premises and obtaining information about the goods for display on the website;
preparing an online catalog of the goods;
displaying the goods on the website for viewing;
establishing and announcing a date for a live auction at the seller's premises;
conducting and broadcasting a live auction with an auctioneer that is visually available by streaming video for viewing in real time;
receiving bids in real time from registered bidders and announcing the highest bid price;
announcing the winning bid in real time;
notifying the winning bidder; and
receiving payment from the winning bidder for goods purchased.
